(19) United States
(12) Patent Application Publication
(10) Pub. No.: US 2012/0212808 A1
(43) Pub. Date: Aug. 23, 2012

(54) Infrared Lens

(75) Inventors: Yuko Watanabe, Saitama-shi (JP); Minoru Ando, Saitama-shi (JP); Kouji Kawaguchi, Saitama-shi (JP)

(73) Assignee: Tamron Co., Ltd., Saitama-shi (JP)

(21) Appl. No.: 13/402,765

(22) Filed: Feb. 22, 2012

(30) Foreign Application Priority Data
Feb. 22, 2011 (JP) 2011-036229

(51) Int. Cl. G02B 13/14

(52) U.S. Cl. 359/357

(57) ABSTRACT

The present invention is directed to an infrared lens that ensures sufficient quantity of light incident on light receiving elements so as to produce a clear infrared picture. The infrared lens comprises a first or leading lens unit of positive refractivity closer to an object, and a trailing lens unit. The trailing lens unit consists of at least a second group of lens pieces located closer to an imaging plane than the first lens unit, and a third group of lens pieces located closer to the imaging plane than the second group of lens pieces. The trailing lens unit is displaced in any direction perpendicular to the optical axis for compensating for image vibration.

### FIELD OF THE INVENTION

The present invention relates to an infrared lens, and more particularly, to an infrared lens that transmits infrared rays and enables clear imaging and that is suitably used for infrared thermography apparatuses and monitoring cameras. The term ‘infrared rays’ means radiated beams of light ranging from intermediate infrared radiation of 3000 to 5000 nm wavelength range to far infrared radiation of 8000 to 14000 nm wavelength range.

### BACKGROUND OF THE INVENTION

Detectors and vidicons, that sense IR radiations typically of medical or industrial use, especially, far IR radiations of 10000 nm wavelength or slightly higher or lower, are poor in sensitivity. IR transmitting materials such as germanium used for these optical devices generally have refractive index higher than that of ordinary visible light transmitting optical lens materials and therefore have higher reflectivity, and some of these IR transmitting materials are unsatisfactory in IR transmissivity.

Thus, optics of the above-mentioned optical devices for measurement are required to be relatively bright, having greater aperture ratio and smaller F number.

In the prior art, disclosed is an infrared lens with angle of view as wide as 30 degrees that ensures a sufficient back focus relative to a focal length and attains superb optical performance in 7 μm to 14 μm wavelength range, and the infrared lens consists of the first and foremost lens piece L1 having its convex surface faced toward an object and shaped in positive meniscus, an aperture stop, the second lens piece L2 having its concave surface faced toward the object and shaped in negative meniscus, and the third and rearmost lens piece L3 having its convex surface faced toward the object and shaped in positive meniscus. This infrared lens is adapted to meet requirements as expressed in the following formulae (1) and (2):

0.4<|r4|/f<0.82 (1)

0.9<(|r4|+d4)/|r5|<1.10 (2)

where f is a focal length for the whole optics, r4 is a curvature of radius of a surface of the second lens piece L2 closer to the object, r5 is a curvature of radius of a surface of the second lens piece L2 closer to the imaging plane, and d4 is a thickness at the center of the second lens piece L2 (See Patent Document 1 listed below).

Also, disclosed is a hand-shake compensation lens unit with an actuator of simplified mechanism and of quick response, and the lens unit comprises a fixed element (12), a movable element (14), a support means (18) for holding the movable element (14) in a plane in parallel with the fixed element, at least three drive coils attached to the fixed element, drive magnet members (22) provided in the movable element and located in positions relative to the drive coils, a detector means (24) for detecting a position of the movable element relative to the fixed element, and a control means (36), in response to destination command signals to command where to move the movable element, producing coil position command signals for the drive coils, and further in response to the coil position command signals and data of the position of the movable element detected by the detector means, controlling drive current supplied to the drive coils (see Patent Document 2 listed below).

### SOURCES OF CITATIONS ON THE PRIOR ART

### Patent Documents

Patent Document 1—Preliminary Publication of Unexamined Patent Application No. 2010-039243
Patent Document 2—Preliminary Publication of Unexamined Patent Application No. 2006-106177

### SUMMARY OF THE INVENTION

### Problems to be Solved by the Invention

The infrared lens disclosed in Patent Document 1 is 1.10 in F number, and this brings about insufficient quantity of light to obtain a clear image through light receiving elements built in an IR apparatus such as IR thermography devices and IR monitoring cameras. Especially, the IR thermography devices and IR monitoring cameras, when vibrated, permit beams incident on their light receiving element for only a shortened period of time, which leads to fatally insufficient quantity of light to produce a clear image.

The hand-shake compensation lens unit with an actuator disclosed in Patent Document 2 is designed simply for common visible light cameras and is directed to pickup of a static picture without blurring and/or storing a blurred picture, and such a lens is not intended for increase in quantity of light incident on the light receiving elements.

### Object of the Invention

The present invention is made to overcome the aforementioned disadvantages in the prior art infrared lenses, and accordingly, it is an object of the present invention to provide an improved infrared lens that is capable of ensuring sufficient quantity of light incident upon light receiving elements so as to obtain a clear infrared picture.

### Solutions

The present invention is an infrared lens comprising a first or leading lens unit of positive refractivity closer to an object, and a trailing lens unit;

the trailing lens unit consisting of at least a second group of lens pieces located closer to an imaging plane than the first lens unit, and a third group of lens pieces located closer to the imaging plane than the second group of lens pieces;

the trailing lens unit being displaced in any direction perpendicular to the optical axis for compensating for image blur.

The present invention provides the infrared lens capable of ensuring sufficient quantity of light incident on light receiving elements so as to obtain a clear infrared picture.

The first lens unit, having a positive refractivity, permits a light flux transmitting therethrough to converge, and this enables the trailing lens unit to be reduced in diameter and weight, which results in an image blur compensating drive system being of reduced driving power.

Furthermore, a manner of compensating for image blur in which the trailing lens unit is displaced in any direction perpendicular to the optical axis facilitates a splendid shielding performance of the infrared lens, compared with a substitutional manner in which the first lens unit is displaced in any direction perpendicular to the optical axis, and the former manner makes an effect of facilitating protection of the image blur compensation mechanism from force or impact externally applied onto the infrared lens.

The present invention can be exemplified in various aspects as follows:

In a first aspect, the infrared lens has its trailing lens unit further comprised of a fourth group of lens pieces closer to the imaging plane than the third group of lens pieces, and the fourth group of lens pieces has positive refractivity.

In an alternative aspect, the infrared lens has its trailing lens unit further comprised of a fourth group of lens pieces closer to the imaging plane than the third group of lens pieces, and the fourth group of lens pieces has negative refractivity.

In another aspect, the infrared lens has its trailing lens unit further comprised of a fifth group of lens pieces closer to the imaging plane than the fourth group of lens pieces, and the fifth group of lens pieces has positive refractivity.

In an alternative aspect, the infrared lens has its trailing lens unit further comprised of a fifth group of lens pieces closer to the imaging plane than the fourth group of lens pieces, and the fifth group of lens pieces has negative refractivity.

In another aspect, the infrared lens may have its trailing lens unit comprised only of the second and third groups of lens pieces.

In further another aspect, the infrared lens has its trailing lens unit comprised only of the second, third and fourth groups of lens pieces.

In still another aspect, the infrared lens has its trailing lens unit comprised only of the second, third, fourth, and fifth groups of lens pieces.

In yet another aspect, the infrared lens has its second group of lens pieces used to compensate for image blur.

In an alternative aspect, the infrared lens has its third group of lens pieces used to compensate for image blur.

In another alternative aspect, the infrared lens has its fourth group of lens pieces used to compensate for image blur.

In a further alternative aspect, the infrared lens has its fifth group of lens pieces used to compensate for image blur.

In another aspect, the infrared lens has its second and fourth groups of lens pieces displaced for zooming.

In further another aspect, the first lens unit and the trailing lens unit have their respective lens groups all comprised of non-cemented monolithic lens pieces.

In an alternative aspect, the first lens unit and the trailing lens unit have their respective lens groups all comprised of germanium lens pieces.

In a further alternative aspect, the first lens unit and the trailing lens unit have their respective lens groups all comprised of chalcogenide lens pieces.

In another aspect, the infrared lens has its second group of lens pieces exhibiting positive refractivity.

In an alternative aspect, the infrared lens has its second group of lens pieces exhibiting negative refractivity.

In another aspect, the infrared lens has its third group of lens pieces exhibiting positive refractivity.

In an alternative aspect, the infrared lens has its third group of lens pieces exhibiting negative refractivity.

In these aspects, sufficient quantity of light incident upon light receiving elements is ensured to more efficiently produce a clear infrared picture.

The trailing lens unit can be reduced in diameter and weight, and this results in an image blur compensating drive system being of reduced driving power.

### BRIEF DESCRIPTION OF THE DRAWING

FIG. 1 is a sectional view of optics of a first embodiment of an infrared lens in accordance with the present invention;

FIG. 2 is a graph illustrating spherical aberration observed in the first embodiment of the infrared lens;

FIG. 3 is a graph illustrating field curvature observed in the first embodiment of the infrared lens;

FIG. 4 is a graph illustrating distortion observed in the first embodiment of the infrared lens;

FIG. 5 is a sectional view of optics of a second embodiment of the infrared lens in accordance with the present invention;

FIG. 6 is a graph illustrating spherical aberration in the second embodiment of the infrared lens;

FIG. 7 is a graph illustrating field curvature in the second embodiment of the infrared lens;

FIG. 8 is a graph illustrating distortion in the second embodiment of the infrared lens;

FIG. 9 is a sectional view of optics of a third embodiment of the infrared lens taking a wide-angle posture in accordance with the present invention;

FIG. 10 is a graph illustrating spherical aberration in the third embodiment of the infrared lens taking the wide-angle posture;

FIG. 11 is a graph illustrating field curvature in the third embodiment of the infrared lens taking the wide-angle posture;

FIG. 12 is a graph illustrating distortion in the third embodiment of the infrared lens taking the wide-angle posture;

FIG. 13 is a sectional view of optics of the third embodiment of the infrared lens taking a tele-photographing posture in accordance with the present invention;

FIG. 14 is a graph illustrating spherical aberration in the third embodiment of the infrared lens taking the tele-photographing posture;

FIG. 15 is a graph illustrating field curvature in the third embodiment of the infrared lens taking the tele-photographing posture;

FIG. 16 is a graph illustrating distortion in the third embodiment of the infrared lens taking the tele-photographing posture;

FIG. 17 is a sectional view of optics of the fourth embodiment of the infrared lens at taking a wide-angle posture in accordance with the present invention;

FIG. 18 is a graph illustrating spherical aberration in the fourth embodiment of the infrared lens taking the wide-angle posture;

FIG. 19 is a graph illustrating field curvature in the fourth embodiment of the infrared lens taking the wide-angle posture;

FIG. 20 is a graph illustrating distortion in the fourth embodiment of the infrared lens taking the wide-angle posture;

FIG. 21 is a sectional view of optics of the fourth embodiment of the infrared lens taking the tele-photographing posture in accordance with the present invention;

FIG. 22 is a graph illustrating spherical aberration in the fourth embodiment of the infrared lens taking the tele-photographing posture;

FIG. 23 is a graph illustrating field curvature in the fourth embodiment of the infrared lens taking the tele-photographing posture; and

FIG. 24 is a graph illustrating distortion in the fourth embodiment of the infrared lens taking the tele-photographing posture.

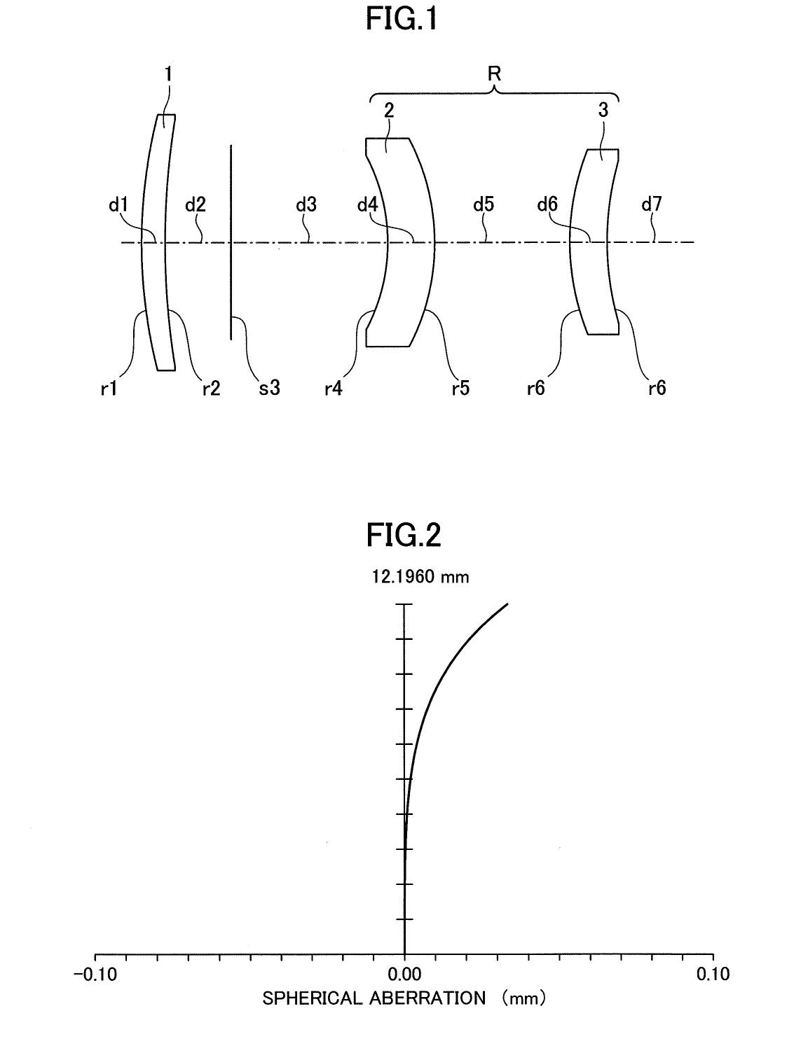

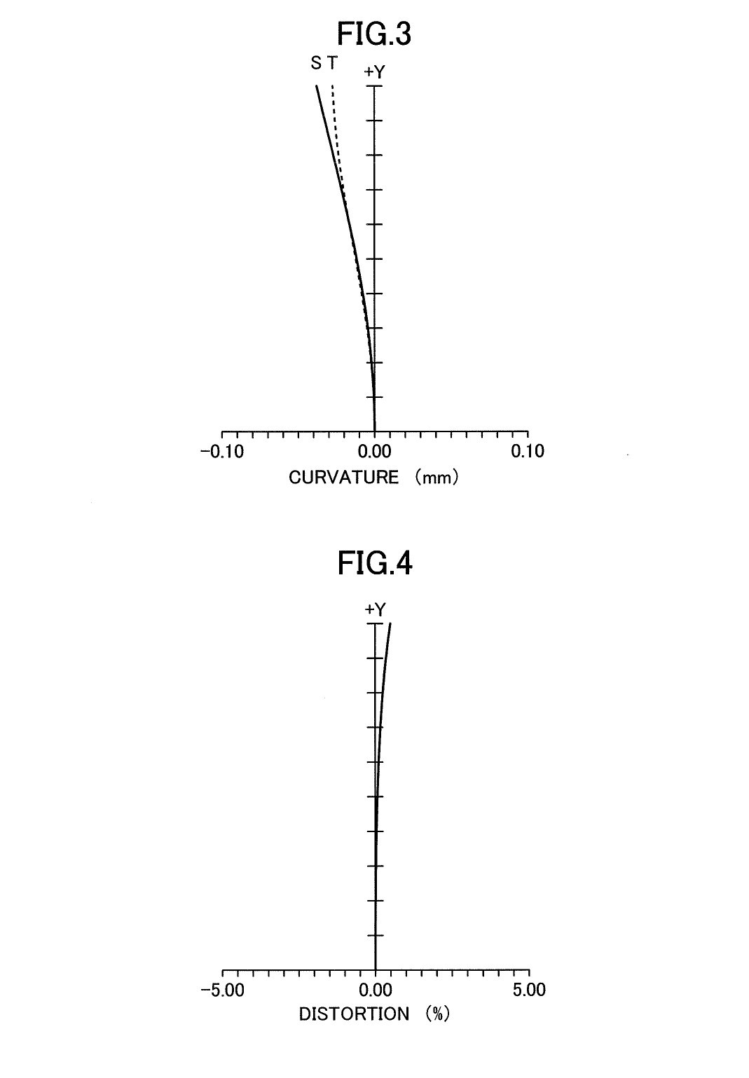

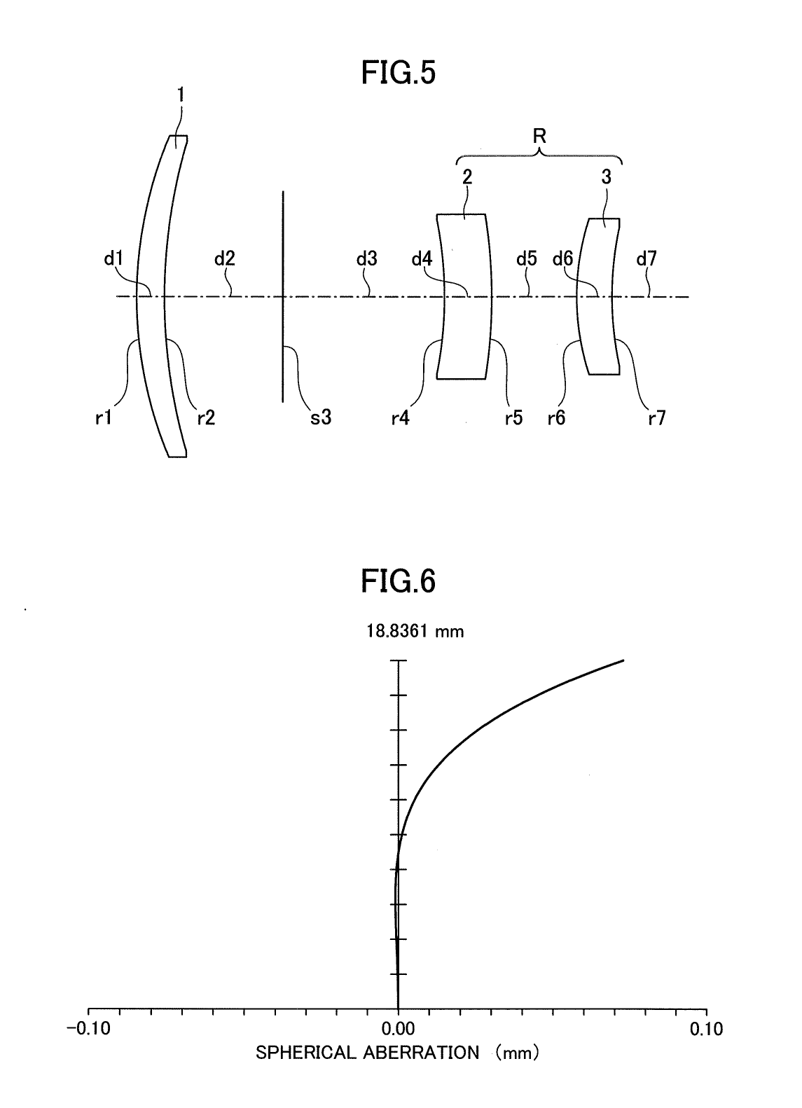

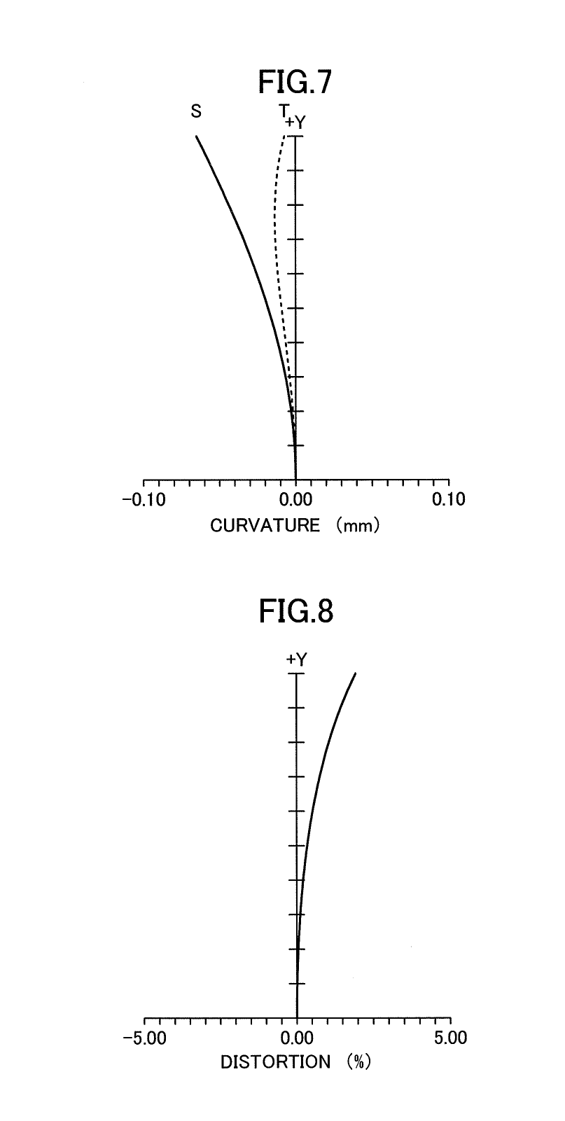

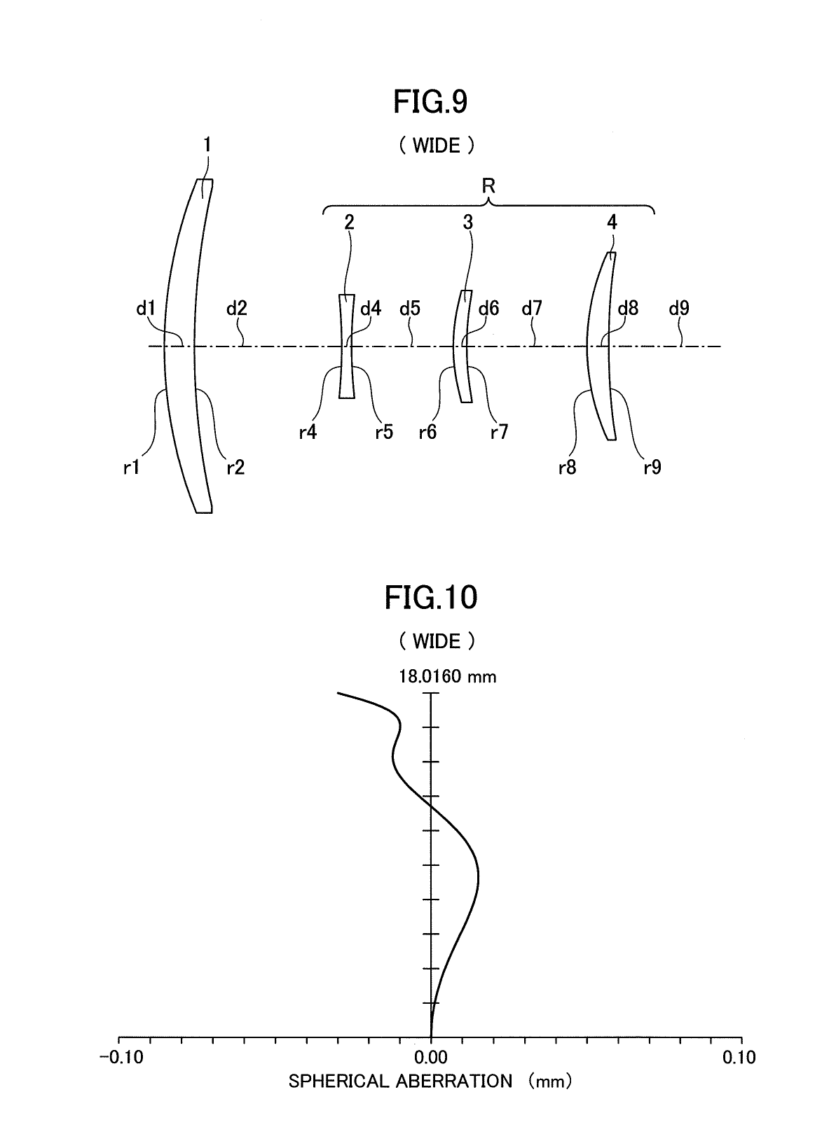

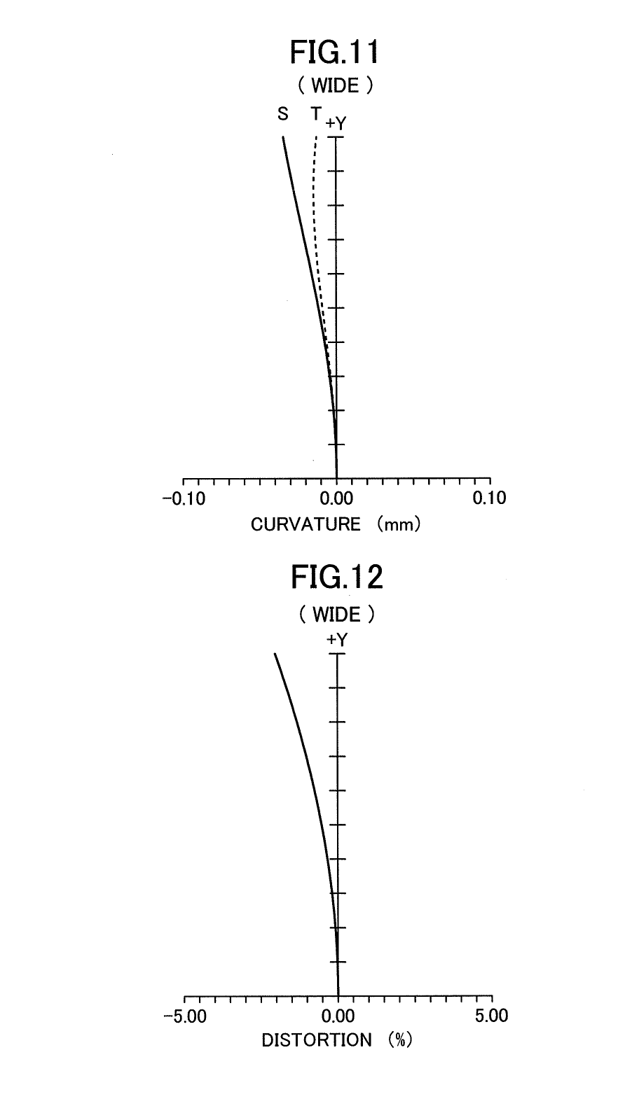

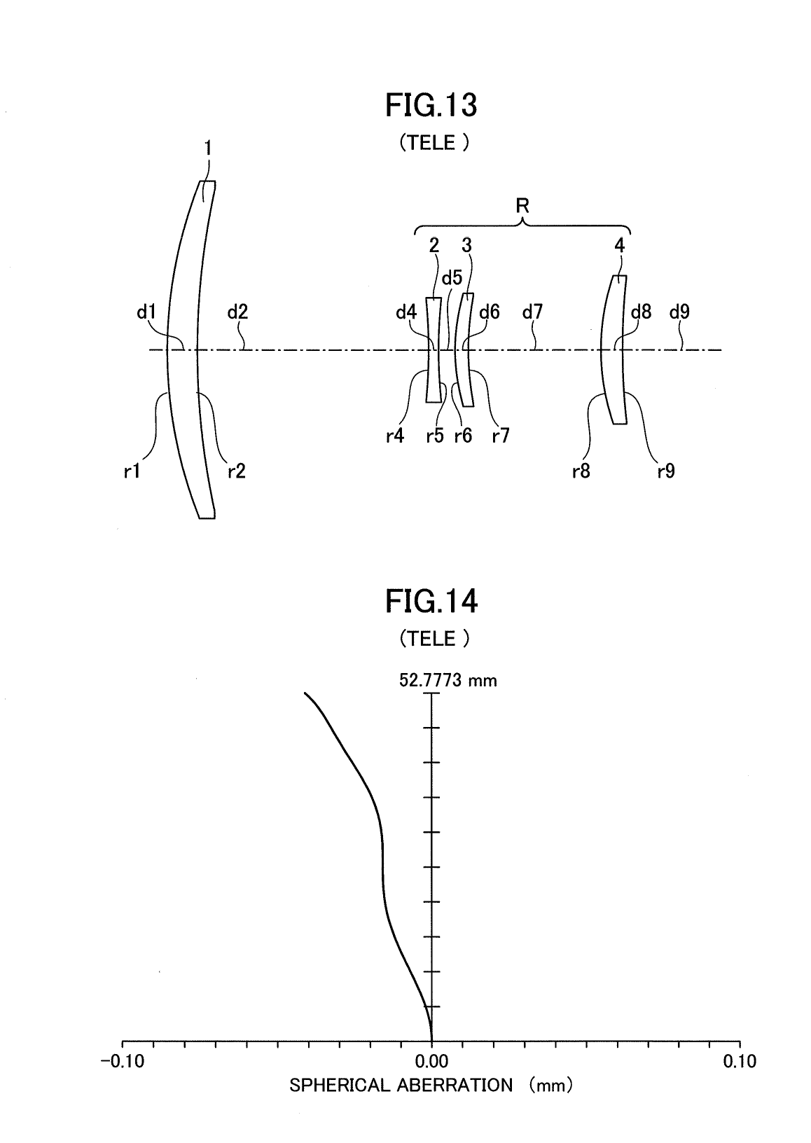

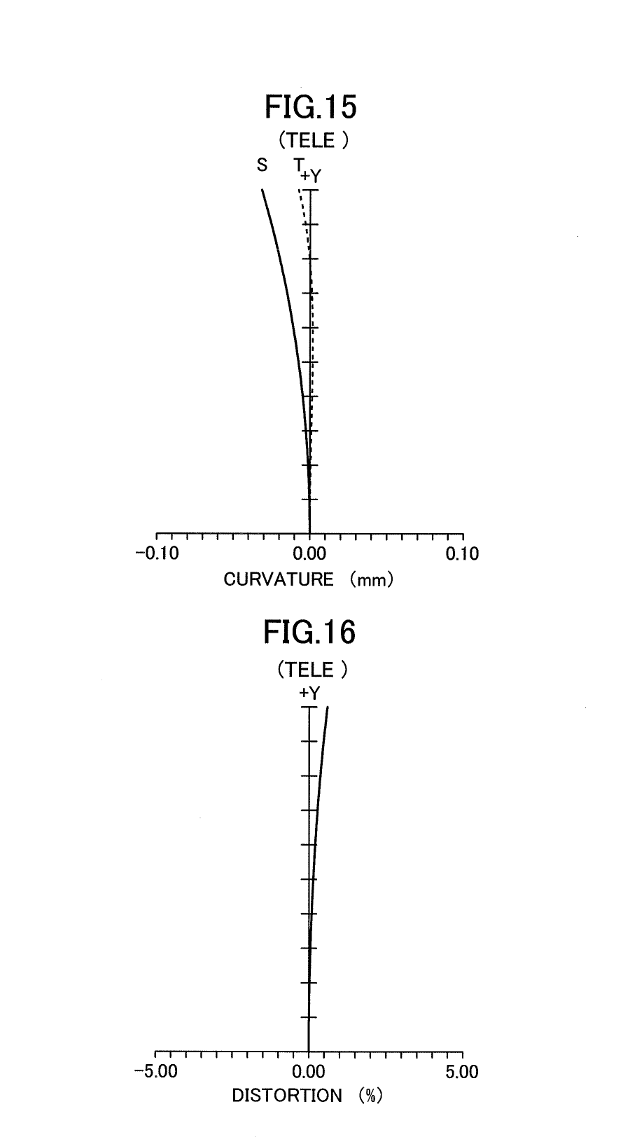

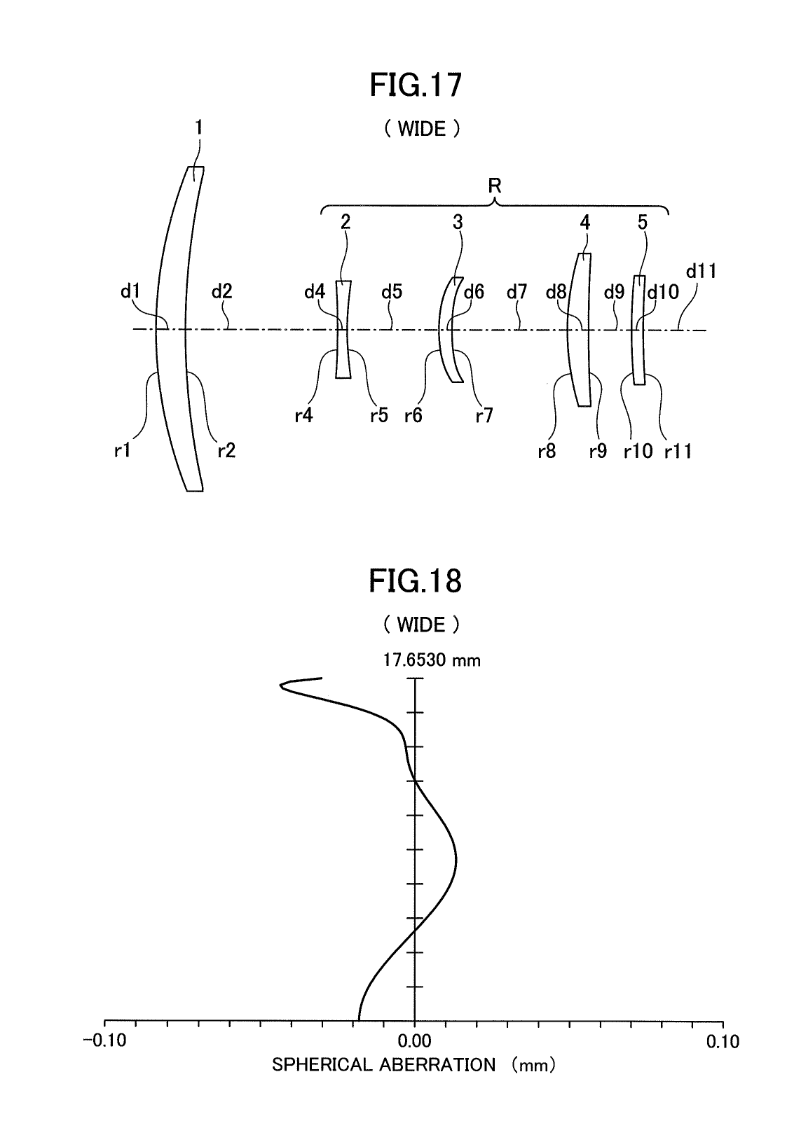

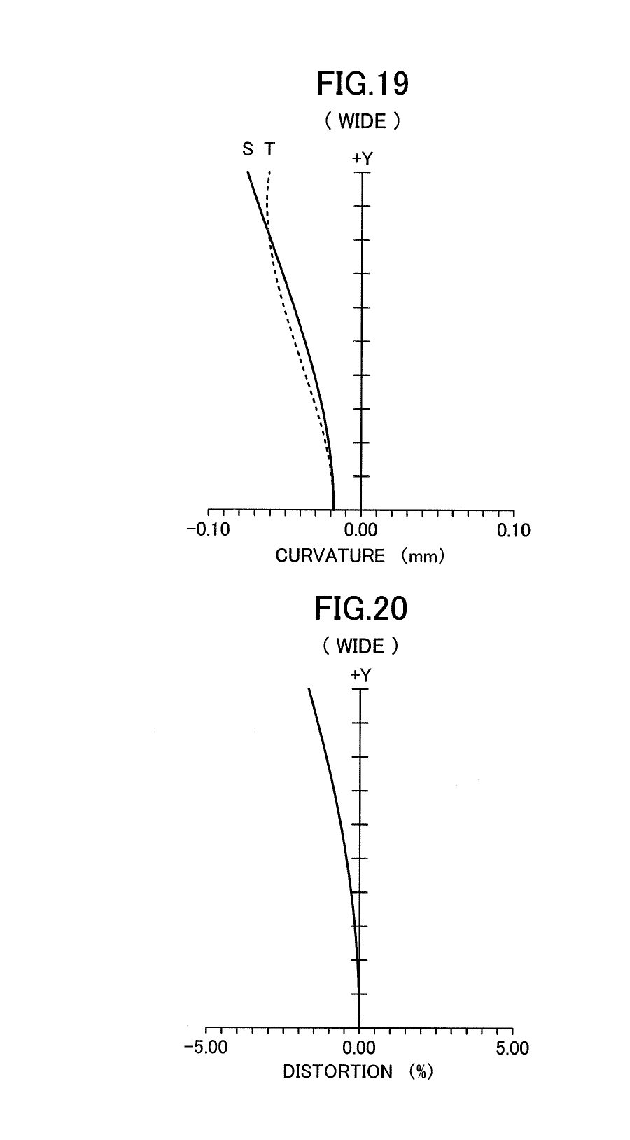

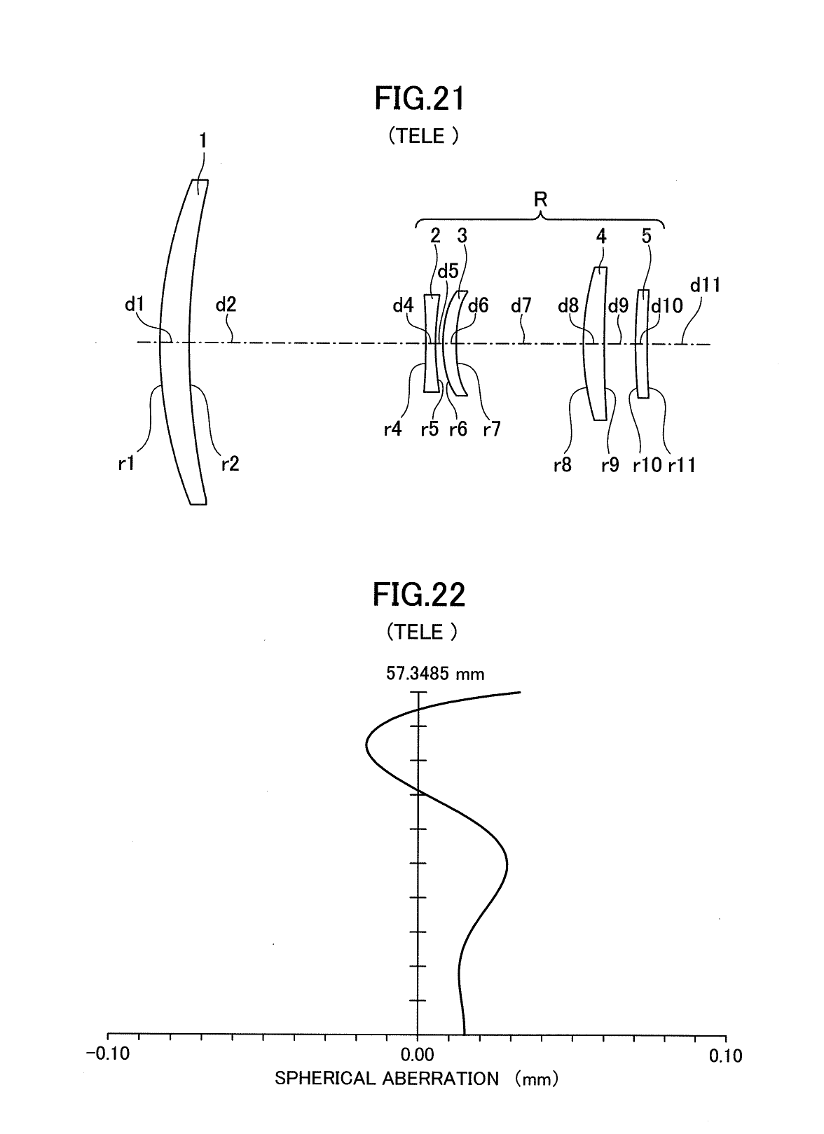

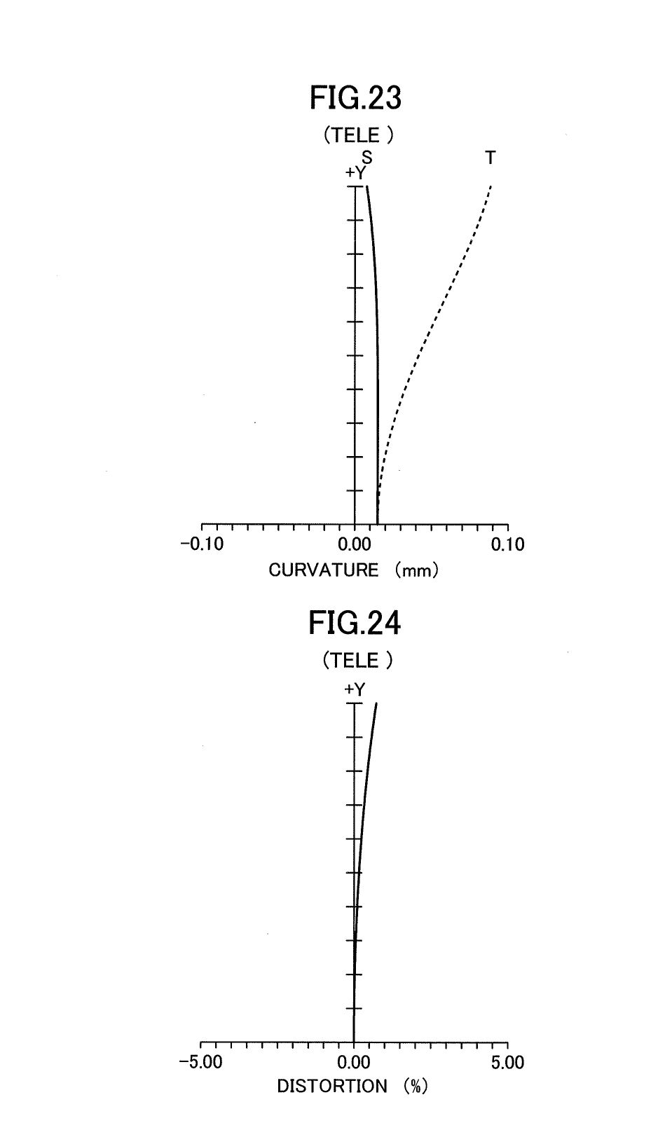

### BEST MODE OF THE INVENTION

Lens parameters and other data of embodiments of an infrared lens according to the present invention will now be provided.

### Embodiment 1

This embodiment of the infrared lens consists of three lens groups and three lens pieces, namely, the first to the third.

| Entire Length of the Optics | 58.96 mm |
|---|---|
| Back Focus | 9.26 mm |
| ½ Angle of View | 8.9 |

| | | Interval | | | |
|---|---|---|---|---|---|
| | Radius of | btwn | | Refractive | |
| Surface # | Curvature | Surfaces | Radius | Index | Focal Length |
| 1 | 52.2813 | 2.5 | 13.2 | 4.0032 | 48.604 |
| | | | | | (Germanium) |
| 2 | 78.5343 | 7.0 | 12.8 | | |
| Stop | | 16.817 | 10.0 | | |
| 3 | −18.5258 | 5.0 | 9.0 | 4.0032 | 4514.299 |
| | | | | | (Germanium) |
| 4 | −22.2464 | 14.383 | 10.8 | | |
| 5 | 24.747 | 4.0 | 9.6 | 4.0032 | 30.856 |
| | | | | | (Germanium) |
| 6 | 29.669 | 4.0 | 8.5 | | |

When the second lens piece (having its opposite surfaces numbered by 3 and 4) is displaced in any direction perpendicular to the optical axis, parameters of the infrared lens are expressed as follows:

| | |
|---|---|
| Deflection Angle | 0.15 |
| Displacement of the Imaging Plane | 0.092 |
| Shift Amount of the Lens | 0.778 |
| Imaging Plane/Shift Amount of the Lens | 0.118 |

When the third lens piece (having its opposite surfaces numbered by 5 and 6) is displaced in any direction perpendicular to the optical axis, the parameters of the infrared lens are as follows:

| | |
|---|---|
| Deflection Angle | 0.15 |
| Displacement of the Imaging Plane | 0.092 |
| Shift Amount of the Lens | 0.231 |
| Imaging Plane/Shift Amount of the Lens | 0.398 |

### Embodiment 2

This embodiment of the infrared lens consists of three groups and three lens pieces, namely, the first to the third.

| Entire Length of the Optics | 69.98 mm |
|---|---|
| Back Focus | 9.68 mm |
| ½ Angle of View | 6.25 |

| | | Interval | | | |
|---|---|---|---|---|---|
| | Radius of | btwn | | Refractive | |
| Surface # | Curvature | Surfaces | Radius | Index | Focal Length |
| 1 | 50.4506 | 3.5 | 19.9 | 4.0032 | 58.254 |
| | | | | | (Germanium) |
| 2 | 67.2052 | 15.0 | 19.3 | | |
| Stop | | 20.547 | 13.0 | | |
| 3 | −47.1008 | 6.0 | 9.5 | 4.0032 | −83.209 |
| | | | | | (Germanium) |
| 4 | −63.5872 | 10.76 | 10.2 | | |
| 5 | 30.5063 | 4.5 | 9.6 | 4.0032 | 30.386 |
| | | | | | (Germanium) |
| 6 | 40.7545 | 4.0 | 8.6 | | |

When the second lens piece (having its opposite surfaces numbered by 3 and 4) is displaced in any direction perpendicular to the optical axis, parameters of the infrared lens are expressed as follows:

| | |
|---|---|
| Deflection Angle | 0.1 |
| Displacement of the Imaging Plane | 0.087 |
| Shift Amount of the Lens | 0.331 |
| Imaging Plane/Shift Amount of the Lens | 0.262 |

When the third lens piece (having its opposite surfaces numbered by 5 and 6) is displaced in any direction perpendicular to the optical axis, the parameters of the infrared lens are as follows:

| | |
|---|---|
| Deflection Angle | 0.1 |
| Displacement of the Imaging Plane | 0.087 |
| Shift Amount of the Lens | 0.216 |
| Imaging Plane/Shift Amount of the Lens | 0.403 |

### Embodiment 3

The infrared lens of this embodiment consists of four lens groups and four lens pieces.

| | WIDE | TELE |
|---|---|---|
| Entire Optical Length | 167.100 mm | 167.100 mm |
| Back Focus | 33.700 mm | 29.840 mm |
| Focal Length | 34.93 | 104.34 |
| F Number | 1.05 | 1.07 |
| ½ Angle of View | 9.1 | 3.0 |
| D2 | 44.29 | 69.88 |
| D4 | 30.59 | 5.0 |
| D6 | 36.02 | 39.88 |
| BEST | 0.005 | −0.028 |

| | | Interval | | | |
|---|---|---|---|---|---|
| | Radius of | btwn | | Refractive | |
| Surface # | Curvature | Surfaces | Radius | Index | Focal Length |
| 1 | 137.576 | 9.0 | 50.7 | 4.0032 | 108.718 |
| | | | | | (Germanium) |
| 2 | 226.09 | D2 | 48.6 | | |
| 3 | −158.358 | 3.0 | 15.8 | 4.0032 | −24.257 |
| | | | | | (Germanium) |
| 4 | 136.825 | D4 | 15.6 | | |
| 5 | 56.757 | 4.0 | 17.0 | 2.6038 | 89.199 |
| | | | | | (Chalcogenide) |
| 6 | 90.0 | D6 | 25.1 | | |
| 7 | 69.083 | 6.5 | 24.3 | 4.0032 | 32.483 |
| | | | | | (Germanium) |
| 8 | 220.0 | | | | |

The second, third, fourth, fifth, and eighth surfaces are all aspherical surfaces that can be expressed by the following formula (3). The sixth surface is a diffractive (DOE) surface that can be expressed by the following formula (4):

$$X = \frac{{H}^{2} / R}{1 + \sqrt{1 - {( {kH}^{2} / R )}^{2}}} + {AH}^{4} + {BH}^{6} + {CH}^{8} \qquad ( 3 )$$

φ(H)=C1H²+C2×H⁴+C3×H⁶ (4)

Asphericity of each of the surfaces of the lens pieces is given as follows:

| Surface # | K | A | B | C |
|---|---|---|---|---|
| 2 | 1.6125 | −6.22E−09 | 4.70E−14 | |
| 3 | 37.599 | 5.24E−07 | 4.26E−09 | −2.00E−12 |
| 4 | −51.371 | 1.03E−06 | 1.11E−09 | −2.44E−12 |
| 5 | 0.343 | 1.43E−07 | 4.10E−09 | −3.78E−11 |
| 6 | 14.589 | −4.99E−07 | 1.78E−11 | −4.38E−11 |
| 8 | 10.1997 | 3.65E−07 | −9.36E−11 | 1.40E−13 |

Diffractive (DOE) coefficients of the sixth surface are given as follows:

| | |
|---|---|
| C1 | −2.11E−04 |
| C2 | −2.66E−07 |
| C3 | −3.12E−09 |
| C4 | −1.20E−11 |
| C5 | −1.70E−14 |

While the whole optics of the infrared lens are taking a wide-angle photographing posture, displacing the third lens piece (having its opposite surfaces numbered by 5 and 6) in any direction perpendicular to the optical axis causes the parameters to have values as follows:

| | |
|---|---|
| Deflection Angle | 0.15 |
| Displacement of the Imaging Plane | 0.091 |
| Shift Amount of the Lens | 0.247 |
| Imaging Plane/Shift Amount of the Lens | 0.368 |

While the whole optics of the infrared lens are taking the wide-angle photographing posture, displacing the fourth lens piece (having its opposite surfaces numbered by 7 and 8) in any direction perpendicular to the optical axis causes the parameters to have values as follows:

| | |
|---|---|
| Deflection Angle | 0.15 |
| Displacement of the Imaging Plane | 0.092 |
| Shift Amount of the Lens | 0.084 |
| Imaging Plane/Shift Amount of the Lens | 1.095 |

While the whole optics of the infrared lens are taking a tele-photographing posture, displacing the third lens piece (having its opposite surfaces numbered by 5 and 6) in any direction perpendicular to the optical axis causes the parameters to have values as follows:

| | |
|---|---|
| Deflection Angle | 0.05 |
| Displacement of the Imaging Plane | 0.092 |
| Shift Amount of the Lens | 0.239 |
| Imaging Plane/Shift Amount of the Lens | 0.385 |

While the whole optics of the infrared lens are taking a tele-photographing posture, displacing the fourth lens piece (having its opposite surfaces numbered by 7 and 8) in any direction perpendicular to the optical axis causes the parameters to have values as follows:

| | |
|---|---|
| Deflection Angle | 0.05 |
| Displacement of the Imaging Plane | 0.092 |
| Shift Amount of the Lens | 0.094 |
| Imaging Plane/Shift Amount of the Lens | 0.979 |

### Embodiment 4

The infrared lens of this embodiment consists of five lens groups and five lens pieces.

| | WIDE | TELE |
|---|---|---|
| Entire Optical | 170.000 mm | 170.000 mm |
| Length | | |
| Back Focus | 19.38 mm | 19.38 mm |
| Focal Length | 32.99 | 108.00 |
| F Number | 1.01 | 1.05 |
| ½ Angle of View | 9.6 | 2.9 |
| D2 | 47.0686 | 73.213 |
| D4 | 28.432 | 2.287 |
| D6 | 35.657 | 39.297 |
| D8 | 13.353 | 9.713 |

| Sur- | Radius | Interval | | | |
|---|---|---|---|---|---|
| face | of | btwn | | Refractive | |
| # | Curvature | Surfaces | Radius | Index1 | Focal Length |
| 1 | 139.7507 | 9.0 | 51.5 | 4.0032 | 109.714 |
| | | | | | (Germanium) |
| 2 | 230.9589 | D2 | 50.2 | | |
| 3 | −500.627 | 3.0 | 15.2 | 4.0032 | −21.830 |
| | | | | | (Germanium) |
| 4 | 75.7793 | D4 | 15.0 | | |
| 5 | 46.8058 | 4.0 | 16.45 | 2.6038 | 77.136 |
| | | | | | (Chalcogenide) |
| 6 | 71.332 | D6 | 16.15 | | |
| 7 | 85.668 | 6.51 | 24.0 | 4.0032 | 34.057 |
| | | | | | (Germanium) |
| 8 | 497.3545 | D8 | 23.4 | | |
| 9 | 172.4688 | 3.6 | 17.5 | 4.0032 | 179.993 |
| | | | | | (Germanium) |
| 10 | 249.3142 | | | | |

The second, third, fourth, fifth, and eighth surfaces are all aspherical surfaces that can be expressed by the following formula (5). The sixth surface is a diffractive (DOE) surface that can be expressed by the aforementioned formula (2):

$$X = \frac{{H}^{2} / R}{1 + \sqrt{1 - ( {kH}^{2} / {R}^{2} )}} + {AH}^{4} + {AH}^{6} + {AH}^{8} + {AH}^{10} + {AH}^{12} \qquad ( 5 )$$

Asphericity of each of the surfaces of the lens pieces is given as follows:

| Surface# | K | A | B | C | D | E |
|---|---|---|---|---|---|---|
| 2 | 1.5006 | −5.35E−10 | −9.38E−13 | 1.68E−16 | | |
| 3 | 666.13 | −1.07E−05 | 3.65E−08 | −3.27E−11 | | |
| 4 | −36.9832 | −2.48E−06 | 1.10E−08 | 2.38E−11 | −7.28E−14 | |
| 5 | 4.6185 | 7.12E−06 | 6.13E−09 | −2.45E−11 | 6.57E−14 | 8.11E−17 |
| 6 | 14.8535 | 1.24E−05 | 1.87E−09 | −3.61E−13 | 4.05E−14 | 1.37E−16 |
| 8 | −11.9058 | 4.26E−07 | 4.69E−11 | −1.53E−14 | | |

Diffractive (DOE) coefficients of the sixth surface are given as follows:

| | |
|---|---|
| C1 | −1.53E−04 |
| C2 | −1.04E−06 |
| C3 | 8.80E−09 |
| C4 | −3.28E−11 |
| C5 | 4.41E−14 |

While the whole optics of the infrared lens are taking a wide-angle photographing posture, displacing the second lens piece (having its opposite surfaces numbered by 3 and 4) in any direction perpendicular to the optical axis causes the parameters to have values as follows:

| | |
|---|---|
| Deflection Angle | 0.15 |
| Displacement of the Imaging Plane | 0.086 |
| Shift Amount of the Lens | 0.111 |
| Imaging Plane/Shift Amount of the Lens | 0.775 |

While the whole optics of the infrared lens are taking the wide-angle photographing posture, displacing the third lens piece (having its opposite surfaces numbered by 5 and 6) in any direction perpendicular to the optical axis causes the parameters to have values as follows:

| | |
|---|---|
| Deflection Angle | 0.15 |
| Displacement of the Imaging Plane | 0.086 |
| Shift Amount of the Lens | 0.223 |
| Imaging Plane/Shift Amount of the Lens | 0.386 |

While the whole optics of the infrared lens are taking the wide-angle photographing posture, displacing the fourth lens piece (having its opposite surfaces numbered by 7 and 8) in any direction perpendicular to the optical axis causes the parameters to have values as follows:

| | |
|---|---|
| Deflection Angle | 0.15 |
| Displacement of the Imaging Plane | 0.086 |
| Shift Amount of the Lens | 0.089 |
| Imaging Plane/Shift Amount of the Lens | 0.966 |

While the whole optics of the infrared lens are taking the wide-angle photographing posture, displacing the fifth lens piece (having its opposite surfaces numbered by 9 and 10) in any direction perpendicular to the optical axis causes the parameters to have values as follows:

| | |
|---|---|
| Deflection Angle | 0.15 |
| Displacement of the Imaging Plane | 0.086 |
| Shift Amount of the Lens | 0.725 |
| Imaging Plane/Shift Amount of the Lens | 0.119 |

While the whole optics of the infrared lens are taking a tele-photographing posture, displacing the second lens piece (having its opposite surfaces numbered by 3 and 4) in any direction perpendicular to the optical axis causes the parameters to have values as follows:

| | |
|---|---|
| Deflection Angle | 0.05 |
| Displacement of the Imaging Plane | 0.094 |
| Shift Amount of the Lens | 0.068 |
| Imaging Plane/Shift Amount of the Lens | 1.382 |

While the whole optics of the infrared lens are taking the tele-photographing posture, displacing the third lens piece (having its opposite surfaces numbered by 5 and 6) in any direction perpendicular to the optical axis causes the parameters to have values as follows:

| | |
|---|---|
| Deflection Angle | 0.05 |
| Displacement of the Imaging Plane | 0.094 |
| Shift Amount of the Lens | 0.24 |
| Imaging Plane/Shift Amount of the Lens | 0.391 |

While the whole optics of the infrared lens are taking the tele-photographing posture, displacing the fourth lens piece (having its opposite surfaces numbered by 7 and 8) in any direction perpendicular to the optical axis causes the parameters to have values as follows:

| | |
|---|---|
| Deflection Angle | 0.05 |
| Displacement of the Imaging Plane | 0.094 |
| Shift Amount of the Lens | 0.107 |
| Imaging Plane/Shift Amount of the Lens | 0.879 |

While the whole optics of the infrared lens are taking a tele-photographing posture, displacing the fifth lens piece (having its opposite surfaces numbered by 9 and 10) in any direction perpendicular to the optical axis causes the parameters to have values as follows:

| | |
|---|---|
| Deflection Angle | 0.05 |
| Displacement of the Imaging Plane | 0.094 |
| Shift Amount of the Lens | 0.793 |
| Imaging Plane/Shift Amount of the Lens | 0.119 |

What is claimed is:

1. An infrared lens comprising a first or leading lens unit of positive refractivity closer to an object, and a trailing lens unit;
the trailing lens unit consisting of at least a second group of lens pieces located closer to an imaging plane than the first lens unit, and a third group of lens pieces located closer to the imaging plane than the second group of lens pieces;
the trailing lens unit being displaced in any direction perpendicular to the optical axis for compensating for image blur.

2. The infrared lens according to claim 1, wherein the trailing lens unit is comprised of a fourth group of lens pieces closer to the imaging plane than the third group of lens pieces, and the fourth group of lens pieces has positive refractivity.

3. The infrared lens according to claim 1, wherein the trailing lens unit is comprised of a fourth group of lens pieces closer to the imaging plane than the third group of lens pieces, and the fourth group of lens pieces has negative refractivity.

4. The infrared lens according to claim 1, wherein the trailing lens unit is comprised of a fifth group of lens pieces closer to the imaging plane than the fourth group of lens pieces, and the fifth group of lens pieces has positive refractivity.

5. The infrared lens according to claim 1, wherein the trailing lens unit is comprised of a fifth group of lens pieces closer to the imaging plane than the fourth group of lens pieces, and the fifth group of lens pieces has negative refractivity.

6. The infrared lens according to claim 1, wherein the trailing lens unit is comprised only of the second and third groups of lens pieces.

7. The infrared lens according to claim 1, wherein the trailing lens unit is comprised only of the second, third and fourth groups of lens pieces.

8. The infrared lens according to claim 1, wherein the trailing lens unit is comprised only of the second, third, fourth, and fifth groups of lens pieces.

9. The infrared lens according to claim 1, wherein the second group of lens pieces is used to compensate for image blur.

10. The infrared lens according to claim 1, wherein the third group of lens pieces is used to compensate for image blur.

11. The infrared lens according to claim 2, wherein the fourth group of lens pieces is used to compensate for image blur.

12. The infrared lens according to claim 4, wherein the fifth group of lens pieces is used to compensate for image blur.

13. The infrared lens according to claim 4, wherein the second and fourth groups of lens pieces are displaced for zooming.

14. The infrared lens according to claim 1, wherein the first lens unit and the trailing lens unit have their respective lens groups all comprised of non-cemented monolithic lens pieces.

15. The infrared lens according to claim 1, wherein the first lens unit and the trailing lens unit have their respective lens groups all comprised of germanium lens pieces.

16. The infrared lens according to claim 1, wherein the first lens unit and the trailing lens unit have their respective lens groups all comprised of chalcogenide lens pieces.

17. The infrared lens according to claim 1, wherein the second group of lens pieces has positive refractivity.

18. The infrared lens according to claim 1, wherein the second group of lens pieces has negative refractivity.

19. The infrared lens according to claim 1, wherein the third group of lens pieces has positive refractivity.

20. The infrared lens according to claim 1, wherein the third group of lens pieces has negative refractivity.
